(19) United States
(12) Patent Application Publication
(10) Pub. No.: US 2004/0080072 A1
(43) Pub. Date: Apr. 29, 2004

(54) Composite material derived from municipal solid waste

(76) Inventors: Floyd E. Bouldin, McMinnville, TN (US); Thomas E. Cantrell, McMinnville, TN (US)

Correspondence Address: STITES & HARBISON, PLLC, 400 W MARKET ST, SUITE 1800, LOUISVILLE, KY, 40202-3352, US

(21) Appl. No.: 10/278,220

(22) Filed: Oct. 23, 2002

(51) Int. Cl. B29C 47/00

(52) U.S. Cl. 264/140; 264/211

(57) ABSTRACT

Composite material derived from municipal solid waste by a transformation process comprising the following steps: providing a quantity of municipal solid waste having a first volume and a liquid content; inserting the first volume of municipal solid waste into a hydrolizer; processing the municipal solid waste within the hydrolizer when the hydrolizer has a steam filled outer jacket at a prescribed pressure and temperature; removing the processed municipal solid waste from the interior of the hydrolizer; and wherein the composite material is at least partially comprised of the processed municipal solid waste according to the above process.

### BACKGROUND OF THE INVENTION

1. Field of the Invention

The present invention is primarily directed to a method of reducing and converting (hereinafter “processing”) garbage and rubbish (hereinafter “municipal solid waste” or “MSW”) into useful composite material. The inventive composite material is thereby a product of an inventive process. The process and the material have unique characteristics. The material has a uniform texture, nutrient composition and initial sterility when produced.

2. Description of the Related Art

By far the most common method of solid waste disposal in the United States is the landfill. The second most common form of disposal is incineration. Composting of solid wastes accounts for only an insignificant amount.

In modern landfills the refuse is spread in thin layers, each of which is compacted by heavy industrial equipment before the next layer is spread. When about ten feet of refuse has been deposited, it is covered by a thin layer of clean earth which also is compacted. Pollution of surface and groundwater is believed to be minimized by lining and contouring the fill, compacting and planting the cover, selecting proper soil, diverting upland drainage, and placing wastes in sites not subject to flooding or high groundwater levels.

Land-filling does pose many problems and concerns, including rising landfill maintenance and development costs, decreasing availability of landfill sites, and an increasing risk that substances leaching from landfills may contaminate groundwater and surface water. Landfills are also known to generate flammable gases through the anaerobic decomposition of the organic solid waste and thus proper venting and burning of the gases, usually methane, is often necessary to eliminate or alleviate potentially dangerous conditions.

Until now a sanitary landfill was considered the cheapest most satisfactory means of disposal, but only if suitable land is available for use within an “economic range” of the source of the wastes (i.e., geographic proximity making waste removal and hauling economically feasible), because collection and transportation costs are known to account for seventy-five percent of the total cost of solid waste disposal and management.

A growing trend associated with the treatment and handling of solid waste material is “resource recovery”. Resource recovery is intended to recover useful materials from raw municipal solid waste. The handling of such wastes may include preprocessing the MSW with grinding or shredding machines, magnetic separators, air classification that separates the light and heavy fractions, screening, and/or washing. Resource recovery methods, therefore, attempt to reduce (i.e., recycle) the solid waste into a more manageable, although not always useful form, but such methods are known to be quite costly.

In all known methods of solid waste disposal (e.g., reduction, treatment or resource recovery), the resultant end product may further include germs that require careful consideration and handling prior to disposal. In such cases the by-products are believed to remain waste materials not suitable for use or transformation into useful articles.

Prior to the existence of the inventive method and resultant composite product associated with it, it had been reported that even under ideal circumstances in selected localities only about 25 percent of municipal solid wastes could be composted and used in land based disposal systems. However, the organic compost material and the inventive composite material can be used to amend the soil and is believed not only capable of improving soil quality, but also serve as an environmentally safe and economically sound method of waste disposal. The inventive material is, therefore, a useful product similar to compost produced by conventional means yet far superior for many reasons.

Until now, a potential drawback associated with the use of MSW compost as a useful material is variability in composition depending on the initial composition of the feedstock. While slight variations in texture, particle size and mineral composition may be of less consequence when the material is used, for example, as a landscape mulch, these factors may be of significant importance when combined with other constituents in the limited volume of a plant container. The reason for this is the microorganisms involved in organic waste degradation also need carbon as an energy source and nitrogen for protein synthesis. The carbon-to-nitrogen ratio required by these microorganisms is about 30-to-1, whereas, municipal solid waste has a much larger ratio sometime as high as 150-to-1 or higher. The inventive composite material derived from the inventive method has a carbon to nitrogen ratio of approximately 50-to-1 and is fairly consistent at this level despite variations in the feed stock stream.

Thus, nitrogen and other nutrients must be added to reduce the carbon-to-nitrogen or add certain other material characteristics of the conventional MSW composite material prior to its use which in turn enhances the composting process, extrusion or molding processes when making useful articles having specific characteristics.

With a consistent carbon to nitrogen ratio in a given material useful additives may be introduced thereby promoting specific material characteristics. Thus, the inventive composite material product derived from MSW by the inventive system is the most uniform and consistent organic material and is useful for compost, and making useful articles such as limber substitutes and concrete substitutes. In its natural state the material is dry and inert and stable.

Furthermore, it is believed that the present invention and related method remedies the concerns over end product variation entirely when using an MSW derived product for making useful articles.

The art to which the inventive system relates includes the information of the type disclosed in U.S. Pat. No. 6,017,475 granted to Cantrell which is incorporated by reference as if fully set forth herein. The '475 patent is directed to a process of transforming household garbage into useful materials.

### SUMMARY OF THE INVENTION

The raw material to be processed undergoes a preprocessing step in which it is shredded, ground, and if necessary dewatered prior to insertion into the hydrolizer for the actual processing (i.e., pressure cooking) step takes place.

The preferred preprocessing portion of the present invention preferably includes at least one grinder and at least one shredder or other material reduction apparatus used to reduce the incoming particle size of the household garbage to a more useful particle size, a dewatering press, and a hydrolizer for metamorphically processing the volume reduced garbage.

The resultant shredded and ground material or raw material “cake” is then transferred, either automatically or manually, to a dewatering press in order to uniformly hydrate the material prior to its introduction into the hydrolizer.

The preferred embodiment of the at least one grinder apparatus is manufactured and sold by Bouldin & Lawson, Inc., of McMinnville, Tenn. The preferred embodiment of the at least one shredder apparatus is distributed by Bouldin & Lawson, Inc., of McMinnville, Tenn. The preferred embodiment of the inventive hydrolizer apparatus is available from WastAway Services, LLC of McMinnville, Tenn.

The hydrolizer includes an outer containment vessel having an exterior jacket and an interior pressure vessel. An airspace exists between the interior vessel and the jacket. A heated steam inlet and exit are attached to the jacket and communicate with the air space. When the material cake is introduced into the interior of the hydrolizer pressure vessel automatically by an inventive gate system, the operator introduces heated stem into the air space surrounding the interior vessel to heat the interior vessel and the material cake inside it. Of course, preheating of the vessel jacket by introducing of steam therein prior to introducing the material cake into the hydrolizer is also acceptable.

A preferred temperature of the steam in the outer jacket is 350 degrees. Of course, the process of the present invention could be carried out at other temperatures and pressures within permissible ranges, but the associated time for completion of the inventive process at other than the preferred temperature and pressure will vary significantly. The greater the temperature and pressure in the hydrolizer the faster the chemical reactions will generally occur, however, a practical efficient maximum temperature and pressure also exists at the preferred levels.

The pressure and temperature, in conjunction with the preprocessed composition of the material cake, acts as the catalyst to speed the chemical reaction of decomposition of the material cake within the vessel. This high temperature and pressure environment causes the material cake to rapidly decompose into its basic constituent elements, and allows them to recombine or remain in their organic cellulose form, and it kills bacteria once living within the material cake.

When the processing is complete, the material cake is transformed into a sterile aggregate cellulose composite material. The aggregate composite material is a mixture of cellulose fibers and other elements present in the material cake prior to processing. The aggregate cellulose material is then dried and preferably remanufactured into useful articles such as compressed bales of material prior to composting or other molded and/or extruded articles through molding and extruding processes. Chemical or natural additives may be added to enhance the material characteristics or add supplemental material characteristics as needed. In any case, the aggregate cellulose material can be used to manufacture plasticene cross ties, and building materials such as bricks, boards and blocks, etc., or naturally land applied as compost material.

The present inventive method may, therefore, be summarized in a variety of ways, one of which is the following: a method of transforming municipal solid waste, garbage or rubbish into useful material, comprising the following steps, providing a quantity of municipal solid waste having a first volume and a liquid content, preprocessing the municipal solid waste having the first volume and liquid content into a second volume of municipal solid waste wherein the second volume is smaller than the first volume, inserting the second volume of municipal solid waste into a hydrolizer, processing the municipal solid waste within the hydrolizer when the hydrolizer has a steam filled outer jacket at a prescribed pressure and temperature, and removing the processed municipal solid waste from the interior of the hydrolizer.

The step of inserting the MSW into the hydrolizer preferably further includes continuously feeding the preprocessed municipal solid waste into the hydrolizer in predetermined volumes. Similarly, the step of removing the processed MSW from the hydrolizer further includes continuously removing the processed municipal solid waste from the hydrolizer in predetermined volumes. The continuous operations of either feeding or removing the MSW into or out of the hydrolizer preferably includes the automatic operation of these tasks by machine.

The preprocessing step of the present invention preferably includes extracting the liquid from wet portions of the municipal solid waste and redistributing the liquid to the dry portions of the municipal solid waste to create a substantially uniform hydration level throughout the volume of preprocessed municipal solid waste.

The preferred method of the present invention may also include the following: an optional drying step, extruding the processed municipal solid waste and forming a block thereof, molding the extruded processed municipal solid waste into a block or other useful article, purifying the processed municipal solid waste by removing inorganic materials therefrom, and/or mixing the processed municipal solid waste with a plastic material.

The present invention may also be summarized as a composite material derived from a process for transforming municipal solid waste, the process comprising the following steps: providing a quantity of municipal solid waste having a first volume and a liquid content; preprocessing the municipal solid waste having the first volume and liquid content into a second volume of municipal solid waste wherein the second volume is smaller than the first volume; inserting the second volume of municipal solid waste into a hydrolizer; processing the municipal solid waste within the hydrolizer when the hydrolizer has a steam filled outer jacket at a prescribed pressure and temperature; removing the processed municipal solid waste from the interior of the hydrolizer; and wherein the composite material is at least partially comprised of the processed municipal solid waste according to the above process.

The preferred step of inserting further includes continuously feeding the preprocessed municipal solid waste into the hydrolizer in predetermined volumes and continuously removing the composite material from the hydrolizer in predetermined volumes. The preferred step continuous feeding the preprocessed municipal solid waste into the hydrolizer further includes automatically feeding the preprocessed municipal solid waste into the hydrolizer.

The step of continuously removing the composite material from the hydrolizer further includes: automatically removing the composite material from the hydrolizer. The preprocessing step further includes extracting the liquid from wet portions of the municipal solid waste and redistributing the liquid to the dry portions of the municipal solid waste to create a substantially uniform hydration level throughout the volume of preprocessed municipal solid waste.

The step of processing the municipal solid waste within the hydrolizer further comprises the step of: regulating the temperature within the steam jacket of the hydrolizer to be in the range from of 300 degrees to 400 degrees. Regulating the temperature within the hydrolizer to be 350 degrees is also preferred as is regulating the pressure within the steam jacket of the hydrolizer to be in the range from 90 psi to 150 psi.

The preferred handling of the composite material includes drying the composite material that was removed from the interior of the hydrolizer. The step of removing the composite material from the interior of the hydrolizer preferably further includes the step of extruding the composite material and forming a block or purifying the processed municipal solid waste by removing inorganic materials such as plastic or metal fragments therefrom. A single or a plurality of nutrient additives may be incorporated into the composite material.

The present invention may also be summarized as composite material derived from municipal solid waste by a transformation process comprising the following steps: providing a quantity of municipal solid waste having a first volume and a liquid content; inserting the first volume of municipal solid waste into a hydrolizer; processing the municipal solid waste within the hydrolizer when the hydrolizer has a steam filled outer jacket at a prescribed pressure and temperature; removing the processed municipal solid waste from the interior of the hydrolizer; and wherein the composite material is at least partially comprised of the processed municipal solid waste according to the above process.

### BRIEF DESCRIPTION OF THE DRAWINGS

FIG. 1 is a flow chart diagram of the various fundamental processing steps associated with the inventive method of the present invention.

### DETAILED DESCRIPTION OF THE PREFERRED EMBODIMENT(S)

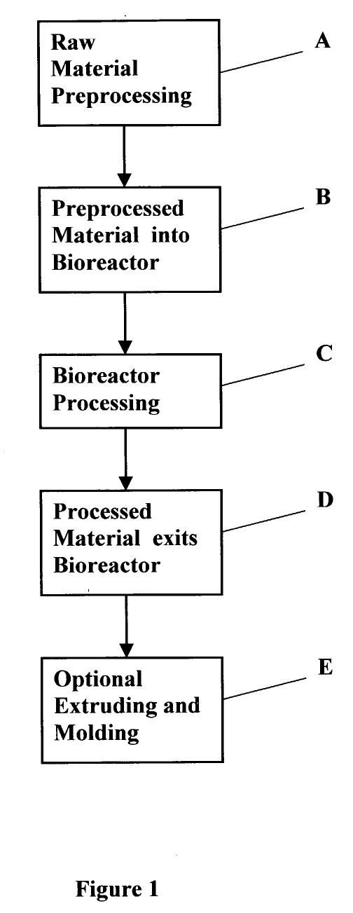

The preferred embodiment of the inventive method is graphically depicted in FIG. 1. The various steps associated with the method can therefore be fundamentally and generally described in the flow chart. The raw municipal solid waste (“MSW”) undergoes preprocessing which consists of shredding and grinding it to decrease its original volume and dewatering the shredded and ground material in order to uniformly hydrate the it (please refer to “A” of FIG. 1).

The preprocessed material cake is then introduced into the hydrolizer supplied by WastAway Services, LLC of McMinnville, Tenn. The WastAway Services hydrolizer resembles a conventional hydrolyzer used in the meat and poultry rendering industries to render animal carcasses and parts thereof. The material input system is available from WastAway Services, LLC of McMinnville, Tenn. It allows the input of material continuously while maintaining the interior pressure and temperature of the hydrolizer (please refer to “B” of FIG. 1).

The preprocessed MSW is then processed within the interior of the hydrolizer for a given length of time depending upon the user selected temperature and pressure within the steam jacket and hydrolizer interior. (Please refer to “C” of FIG. 1). The preferred temperature and thus the pressure of the steam jacket is 350 degrees.

After the allotted time within the hydrolizer has elapsed (i.e., “resident” or “in vessel time”) the material exits the hydrolizer automatically by operation of the material exit system available from WastAway Services, LLC of McMinnville, Tenn. The exiting material is hot and thus care is taken to capture the material upon exit. (Please refer to “D” of FIG. 1).

The processed material that is captured upon exit of the hydrolizer can be dried or introduced into an extruding apparatus which in turn, but preferably as a continuous phase, deposits the extruded material into a mold for compressive formation of useful articles or blocks of processed material. (Please refer to “E” of FIG. 1).

What is claimed is:

1. A composite material derived from a process for transforming municipal solid waste, the process comprising the following steps:
providing a quantity of municipal solid waste having a first volume and a liquid content;
preprocessing the municipal solid waste having the first volume and liquid content into a second volume of municipal solid waste wherein the second volume is smaller than the first volume;
inserting the second volume of municipal solid waste into a hydrolizer;
processing the municipal solid waste within the hydrolizer when the hydrolizer has a steam filled outer jacket at a prescribed pressure and temperature;
removing the processed municipal solid waste from the interior of the hydrolizer; and
wherein the composite material is at least partially comprised of the processed municipal solid waste according to the above process.

2. The process of claim 1, wherein the inserting step further includes:
continuously feeding the preprocessed municipal solid waste into the hydrolizer in predetermined volumes and continuously removing the composite material from the hydrolizer in predetermined volumes.

3. The process of claim 2, wherein the step of continuous feeding the preprocessed municipal solid waste into the hydrolizer further includes:
automatically feeding the preprocessed municipal solid waste into the hydrolizer.

4. The process of claim 2, wherein the step of continuously removing the composite material from the hydrolizer further includes:
automatically removing the composite material from the hydrolizer.

5. The process of claim 1, wherein the preprocessing step further includes:
extracting the liquid from wet portions of the municipal solid waste and redistributing the liquid to the dry portions of the municipal solid waste to create a substantially uniform hydration level throughout the volume of preprocessed municipal solid waste.

6. The process of claim 1, wherein the step of processing the municipal solid waste within the hydrolizer further comprises the step of:
regulating the temperature within the steam jacket of the hydrolizer to be in the range from of 300 degrees to 400 degrees.

7. The process of claim 6, further including the step of:
regulating the temperature within the hydrolizer to be 350 degrees.

8. The process of claim 1, wherein the step of processing the municipal solid waste within the hydrolizer further comprises the step of:
regulating the pressure within the steam jacket of the hydrolizer to be in the range from 90 psi to 150 psi.

9. The process of claim 8, further including the step of:
regulating the pressure within the steam jacket of the hydrolizer to be 120.

10. The process of claim 1, further including the step of:
drying the composite material that was removed from the interior of the hydrolizer.

11. The process of claim 1, wherein the step of removing the composite material from the interior of the hydrolizer further includes the step of:
extruding the composite material and forming a block thereof.

12. The process of claim 11, wherein the step of extruding the composite material and forming a block thereof further includes the step of:
molding the extruded composite material into a block.

13. The process of claim 10, further including the step of:
purifying the processed municipal solid waste which contains plastic or metal fragments by removing them.

14. The process of claim 1, further including the step of:
purifying the composite material by removing inorganic materials therefrom.

15. The process of claim 11, further including the step of:
mixing the composite material with a nutrient additive.

16. The process of claim 1, further including the step of:
mixing the composite material with a nutrient additive.

17. The process of claim 15, wherein the step of mixing the composite material further includes the step of:
mixing a plurality of nutrients with the composite material.

18. The process of claim 16, wherein the step of mixing the composite material further includes the step of:
mixing a plurality of nutrients with the composite material.

19. The process of claim 1, wherein the step of removing the processed municipal solid waste from the interior of the hydrolizer further includes the step of:
molding the composite material into a block thereof.

20. The process of claim 14, wherein the step of removing the processed municipal solid waste from the interior of the hydrolizer and purifying the composite material by removing inorganic materials therefrom further includes the step of:
molding the purified composite material into a block thereof.

21. Composite material derived from municipal solid waste by a transformation process comprising the following steps:
providing a quantity of municipal solid waste having a first volume and a liquid content;
inserting the first volume of municipal solid waste into a hydrolizer;
processing the municipal solid waste within the hydrolizer when the hydrolizer has a steam filled outer jacket at a prescribed pressure and temperature;
removing the processed municipal solid waste from the interior of the hydrolizer; and
wherein the composite material is at least partially comprised of the processed municipal solid waste according to the above process.

22. The process of claim 21, wherein the inserting step further includes:
continuously feeding the municipal solid waste into the hydrolizer in predetermined volumes and continuously removing the composite material from the hydrolizer in predetermined volumes.

23. The process of claim 22, wherein the step of continuously feeding the preprocessed municipal solid waste into the hydrolizer further includes:
automatically feeding the preprocessed municipal solid waste into the hydrolizer.

24. The process of claim 22, wherein the step of continuously removing the composite material from the hydrolizer further includes:
automatically removing the composite material from the hydrolizer.

25. The process of claim 21, wherein the step of processing the municipal solid waste within the hydrolizer further comprises the step of:
regulating the temperature within the steam jacket of the hydrolizer to be in the range from of 300 degrees to 400 degrees.

26. The process of claim 25, further including the step of:
regulating the temperature within the hydrolizer to be 350 degrees.

27. The process of claim 21, wherein the step of processing the municipal solid waste within the hydrolizer further comprises the step of:
regulating the pressure within the steam jacket of the hydrolizer to be in the range from 90 psi to 150 psi.

28. The process of claim 27, further including the step of:
regulating the pressure within the steam jacket of the hydrolizer to be 120.

29. The process of claim 21, further including the step of:
drying the composite material that was removed from the interior of the hydrolizer.

30. The process of claim 21, wherein the step of removing the composite material from the interior of the hydrolizer further includes the step of:
extruding the composite material and forming a block thereof.

31. The process of claim 30, wherein the step of extruding the composite material and forming a block thereof further includes the step of:
molding the extruded composite material into a block.

32. The process of claim 21, further including the step of:
purifying the processed municipal solid waste which contains plastic or metal fragments by removing them.

33. The process of claim 29, further including the step of:
purifying the composite material by removing inorganic materials therefrom.

34. The process of claim 21, further including the step of:
mixing the composite material with a nutrient additive.

35. The process of claim 21, further including the step of:
mixing the composite material with a nutrient additive.

36. The process of claim 34, wherein the step of mixing the composite material further includes the step of:
mixing a plurality of nutrients with the composite material.

37. The process of claim 35, wherein the step of mixing the composite material further includes the step of:
mixing a plurality of nutrients with the composite material.

38. The process of claim 21, wherein the step of removing the processed municipal solid waste from the interior of the hydrolizer further includes the step of:
molding the composite material into a block thereof.

39. The process of claim 32, wherein the step of removing the processed municipal solid waste from the interior of the hydrolizer and purifying the composite material by removing inorganic materials therefrom further includes the step of:
molding the purified composite material into a block thereof.
